(19) United States
(12) Patent Application Publication
(10) Pub. No.: US 2008/0143293 A1
(43) Pub. Date: Jun. 19, 2008

(54) Battery charger

(76) Inventor: Silvestre A. Magalhaes, Virginopolis (BR)

Correspondence Address: KILE GOEKJIAN REED & MCMANUS, 1200 NEW HAMPSHIRE AVE, NW, SUITE 570, WASHINGTON, DC, 20036, US

(21) Appl. No.: 11/984,804

(22) Filed: Nov. 21, 2007

(30) Foreign Application Priority Data
Dec. 19, 2006 (BR) PI 0605958-9

(51) Int. Cl. H02J 7/00

(52) U.S. Cl. 320/108

(57) ABSTRACT

A battery charger composed of a transformer, designed to be permanently attached to a local power source. The transformer can be mounted permanently so that the battery operated device can be directly plugged in to the mounted device. Alternatively, the transformer can be designed to plug into the local power source and the battery operated device is, in turn, plugged into the transformer. A cell phone is a preferred battery operated device.

### BACKGROUND OF THE INVENTION

Applicant claims the priority of Brazilian Patent Application No. PI 0605958-9 filed on Dec. 19, 2006.

The invention is a battery charger. In a preferred embodiment the invention is used in connection with recharging battery operated devices, in particular cell phones. The invention comprises a plug for the cell phone (or other battery operated device) and a transformer. The charger is directly connected to the local power supply. In a preferred embodiment, the charger is permanently connected to the local power supply, for example, by connecting household power to the device and mounting the devise on a wall. The charger is further designed so that when it is not actually recharging batteries it does not draw substantial power from the local power supply.

The invention disclosed herein eliminates inconvenient features associated with the prior art battery chargers. In case of the cell phone, for example, the required battery charger, bulky and containing long wires, is generally not easy to carry.

### BRIEF DESCRIPTION OF THE DRAWINGS

FIG. 1 illustrates an adaptor configured to fit between a cell phone and the battery charger.

FIG. 2 illustrates the main body of the charger.

FIG. 3 illustrates the connection of the charger to the local power supply.

### DETAILED DESCRIPTION OF THE PREFERRED EMBODIMENTS

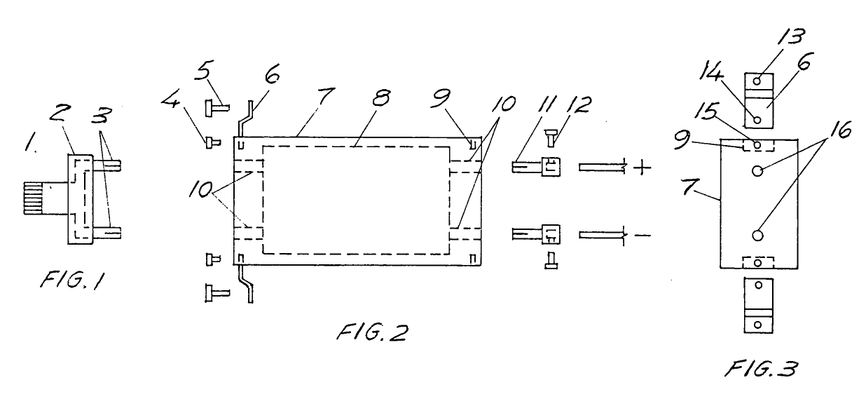

FIGS. 1-3 illustrate a preferred embodiment of the battery charger in exploded view. FIG. 1 illustrates the adapter portion containing elements 1 to 3. The adapter consists of a body 2, constructed of an electric insulator, a plug 1 designed to fit into the cell phone, and a second plug 3, on the opposite side of the body, designed to plug into the main body of the charger. This second plug has two prongs.

FIG. 2 illustrates the main body of the charger. It consists of a transformer 8, in the interior of its protective covering 7. The transformer is designed to convert the electrical power from the form present in the local power supply to the form appropriate for recharging a battery. For example, a typical North American home is serviced by a 120V, 60 Hz electric current. A typical cell phone battery provides 3.6V DC current. Accordingly, the transformer would convert the 120V AC current to the 3.6V DC current. The protective covering 7 is also constructed from an electrical insulator.

Two sets of two rounded holes 10 appear at both ends of the transformer main body 8. These holes are configured to accept plugs and form electrical connections with the two charger components (see FIGS. 1 and 3) on either side of the main body (see FIG. 2). The connection is designed to be generally friction fitting.

FIG. 3 illustrates the component designed to attach the charger to the local AC power supply. A plug comprising a pair of round pins 11 is designed to fit into the holes 10. The pins pass through holes 16 in a protective covering 7. The pins 11 will insert and make an electrical connection with the posterior end of the transformer 8.

The embodiment illustrated in FIGS. 1-3 can be mounted to the local power supply in two configurations. In the first configuration, only the component illustrated in FIG. 3 is permanently mounted to the power supply. In another configuration, described below, the components of FIGS. 2 and 3 are both mounted permanently to the local power supply

In the first configuration, the component of FIG. 3 is connected to the local power supply as follows. Pins 11 are connected to the ends of the local electrical wiring and secured in place with set screws 12. This connection is then covered by protective covering 7 which is mounted, in one embodiment, to the wall using tab 6. This tab is secured to the protective covering 7 by a screw passing though a hole in the tab 14 and a hole in the protective covering 9. The entire combination is then secured to wall by placing nails or screws through the other hole 13 in the tab 6.

In a second configuration, the component illustrated in FIG. 2 is secured to the wall as is illustrated in FIG. 2 in exploded view. In this configuration, a set of brackets 6 are attached to the “cell phone” end of the box (the end that engages the component from FIG. 1). The brackets 6 are secured to the body of the charger 7 using set screws 4 and the combination is attached to the wall using another set of screws 5.

When installation is complete, the invention disclosed herein eliminates the need for a portable charger for each cell phone and also eliminates the cord typically found with prior art cell phone chargers. In a preferred embodiment, multiple devices can be installed in all of the locations where the user charges cell phones. A home builder or landlord can do this, for example, as a value added service. This eliminates the need for the user to carry a cell phone charger. All the user would needs to carry is a simple adapter (FIG. 1) in case the cell phone does not have a socket compatible with the plug featured in the charger.

The battery charger is designed with the proper circuitry so that, even though the charger is attached to the local power supply, the charger will not use any electricity when not in use.

Note that when the charger base is permanently mounted to the wall, using brackets and screws 4-6, then components of FIG. 3 and elements 11 and 12 can be eliminated. Conversely, when only component of FIG. 3 is mounted, then brackets and screws 4-6 can be eliminated. In a preferred embodiment the invention will be sold as a universal kit in which either configuration can be set up as the user prefers. Of course, the invention is not limited to the use of screws, pins or nails but can make use of any known mechanism by which components of these types can be attached and any know mechanism by which electrical connections are made.

What is claimed is:

1. A battery charger comprising:
an adapter having one end configured to engage a battery operated device and another end configured to engage a transformer component, and
a transformer component having one end configured to engage said adapter and another end configured to connect to the local power supply,
wherein said battery charger will charge said battery when the battery operated device is connected to an adapter.

2. A battery charger as defined in claim 1 wherein said battery operated device is a cell phone.

3. A battery charger as defined in claim 1 further comprising:
said transformer is connected to said local power supply through a third component
wherein another end of said transformer is configured to engage said third component, and
said third component is configured to connect to the local power supply.

4. A battery charger as defined in claim 3 wherein said battery operated device is a cell phone.
